(19) United States
(12) Patent Application Publication
(10) Pub. No.: US 2019/0245311 A1
(43) Pub. Date: Aug. 8, 2019

(54) INSULATION-DISPLACEMENT CONNECTION TOOL AND INSULATION-DISPLACEMENT TERMINAL

(71) Applicant: PHOENIX CONTACT GMBH & CO. KG, Blomberg (DE)

(72) Inventor: Andreas WENDT, Berlin (DE)

(21) Appl. No.: 16/318,711

(22) PCT Filed: Jul. 13, 2017
(86) PCT No.: PCT/EP2017/067766

§ 371 Date: Jan. 18, 2019

(30) Foreign Application Priority Data
Aug. 3, 2016 (DE) 10 2016 114 344.8

(51) Int. Cl. H01R 43/01; H01R 4/2454; H01R 12/51

(52) U.S. Cl. CPC H01R 43/015; H01R 12/515; H01R 4/2454

(57) ABSTRACT

A tool for connecting an electrical conductor, which is sheathed by insulation, to an insulation-displacement terminal having at least two contact elements which each form a conductor clamping slot and are configured to make clamping contact with the electrical conductor, includes: a mating bearing element, which can be placed against the contact elements; and a stamp element, which is arranged so as to be movable, relative to the mating bearing element. The stamp element has a receiving element for holding and guiding the electrical conductor, which receiving element is formed and able to insert the electrical conductor into the conductor clamping slots when the stamp element moves, relative to the mating bearing element, out of an application position to a clamping position. The mating bearing element has at least one supporting region which comes into contact with at least one bearing face, which is averted from the conductor clamping slot.

### CROSS-REFERENCE TO PRIOR APPLICATIONS

This application is a U.S. National Phase application under 35 U.S.C. § 371 of International Application No. PCT/EP2017/067766, filed on Jul. 13, 2017, and claims benefit to German Patent Application No. DE 10 2016 114 344.8, filed on Aug. 3, 2016. The International Application was published in German on Feb. 8, 2018 as WO 2018/024461 under PCT Article 21(2).

### FIELD

The present invention relates to a tool for connecting an electrical conductor, which is sheathed by way of an insulation, to an insulation-displacement terminal. The present invention furthermore relates to an insulation-displacement terminal.

### BACKGROUND

Such a tool is known from document DE 43 00 347 A1, for example. By means of the known connecting tool, the electrical conductor is pressed into the conductor clamping slot of the contact elements of an insulation-displacement terminal by means of a stamp. It is disadvantageous that, by means of the known tools, the actuating force required to apply a conductor is transferred directly to the terminal carrier, i.e., for example, to the terminal strip or the circuit board. With increasing cross-section of the electrical conductor, the actuating force therefore increases correspondingly, so that only conductors with a small conductor cross-section, e.g., less than 6 square millimeters, can be connected.

### SUMMARY

In an embodiment, the present invention provides a tool for connecting an electrical conductor, which is sheathed by an insulation, to an insulation-displacement terminal which has at least two contact elements which each form a conductor clamping slot and are configured to make clamping contact with the electrical conductor, the tool comprising: a mating bearing element, which is configured to be placed against the contact elements; and a stamp element, which is arranged so as to be movable, relative to the mating bearing element, the stamp element having a receiving element configured to hold and guide the electrical conductor, which receiving element is formed and configured to insert the electrical conductor into the conductor clamping slots when the stamp element moves, relative to the mating bearing element, out of an application position to a clamping position, wherein the mating bearing element has at least one supporting region which is configured to come into contact with at least one bearing face, which is averted from the conductor clamping slot, of at least one of the contact elements in the application position.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 a perspectival view of the tool according to the invention in an application position,

FIG. 2 a perspectival view of the tool shown in FIG. 1 in an application position,

FIG. 3 a detailed illustration of the details outlined in FIG. 1,

FIG. 4 a detailed illustration of the stamp element, and

FIG. 5 a perspectival view of the insulation-displacement terminal according to the invention.

### DETAILED DESCRIPTION

In an embodiment, the present invention provides a tool for connecting an electrical conductor to an insulation-displacement terminal without outer forces acting on the terminal carrier in the process. In particular, the tool makes it possible to use insulation displacement technology even in the case of large conductor cross-sections, e.g., cross-sections of up to 35 square millimeters. Furthermore, in an embodiment, the present invention provides an insulation-displacement terminal correspondingly suitable for this purpose.

In an embodiment, the present invention provides a tool that has at least two contact elements which each form a conductor clamping slot and are designed to make clamping contact with the electrical conductor, wherein the tool has a mating bearing element, which is designed to be placed against the contact elements, and a stamp element, which is arranged such that it can move, relative to the mating bearing element, wherein the stamp element has a receiving element for holding and guiding the electrical conductor, which receiving element is formed and designed to insert the electrical conductor into the conductor clamping slots when the stamp element moves, relative to the mating bearing element, out of an application position to a clamping position, wherein the mating bearing element has at least one supporting region which is designed to come into contact with at least one bearing face, which faces away from the conductor clamping slot, of at least one of the contact elements in the application position.

Advantageously, the forces acting via the insulation-displacement terminal on the terminal carrier when moving the stamp element or the mating bearing element out of the application position to the clamping position are thus reduced to a minimum. The application process of the electrical conductor onto the insulation-displacement terminal thus takes place essentially free of outside forces, which could otherwise be transferred to the terminal carrier via the insulation-displacement terminal. It is thus possible for the first time to also connect electrical conductors of large cross-section, such as conductors with a cross-section greater than 6 square millimeters, by means of insulation displacement technology. The invention provides that the mating bearing element surround the insulation-displacement terminal in a form-fit manner on the rear side, i.e., on the side facing away from the conductor clamping slots, in order to support the insulation-displacement terminal at its bearing face against the actuating forces required to make clamping contact with the electrical conductor. The forces acting on the insulation-displacement terminal in order to make clamping contact are thus, within the tool according to the invention, absorbed via the mating bearing element such that no, or only extremely low, forces are transferred from the insulation-displacement terminal to the terminal carrier during the clamping process.

Another expedient embodiment of the invention is characterized in that the receiving element comprises a pair of pressing elements assigned to each of the contact elements of the insulation-displacement terminal, which pair is designed to support the electrical conductor during insertion into the respective one of the conductor clamping slots. In this way, the electrical conductor is directly supported in the regions in which corresponding, particularly high, clamping forces occur during insertion into the conductor clamping slots. By means of the pressing elements, the electrical conductor is guided precisely, and an undesirable deformation of the conductor during the clamping process is reliably avoided.

According to a further embodiment of the invention, each of the pairs of pressing elements respectively comprises two pressing elements spaced apart from one another to form a receiving gap for receiving the contact elements. In other words, two of the pressing elements are preferably assigned to each of the contact elements of the insulation-displacement terminal according to the invention and are spaced apart from one another via the receiving gap for the contact element. When moving the stamp element, relative to the mating bearing element, out of the application position to the clamping position, the contact elements of the insulation-displacement terminal thus move into the respective one of the receiving gaps. The respective ones of the pressing elements thus exert pressure on the electrical conductor or its insulation in close proximity to the corresponding one of the contact elements.

In order to achieve as flat a contact as possible and low deformation of the electrical conductor or its insulation, the pressing elements each have concave supporting surfaces. The supporting surfaces are preferably circular arc-shaped, the radius of which is matched to that of the insulation of the electrical conductor.

A further expedient embodiment of the invention is characterized in that the stamp element comprises at least one guide element which is designed and formed to engage in a form-fit manner in at least one guide recess of the insulation-displacement terminal according to the invention, wherein the at least one guide recess is arranged in a connecting region between each of the contact elements of the insulation-displacement terminal. The guide element of the stamp element and the guide recess of the insulation-displacement terminal thus form a guiding aid, which ensures precise alignment of the stamp element, relative to the contact elements of insulation-displacement terminal according to the invention.

An advantageous development of the invention provides that the mating bearing element respectively have lateral guiding surfaces for laterally encompassing the insulation-displacement terminal. The lateral guiding surfaces are, in particular, designed to encompass the insulation-displacement terminal in a form-fit manner. In this way, the mating bearing element is precisely positioned and aligned when applied to the insulation-displacement terminal.

It is also preferably provided that the lateral guiding surfaces be designed in a staircase shape so that, when placing them against the contact elements, the conductor clamping slots are not covered. In this way, an otherwise possible collision between the tool according to the invention and the electrical conductor inserted into the conductor clamping slots in the clamping position is reliably avoided.

According to a further preferred embodiment of the invention, the stamp element and/or the mating bearing element comprises an adjustable limiting device for limiting the minimum distance between the stamp element and the mating bearing element. The insertion depth of the electrical conductor into the conductor clamping slots is particularly easily designed in a presettable manner by means of the limiting device. This offers the advantage that the insertion depth is formed to be adjustable with regard to optimum clamping contact according to the insulation displacement geometry and the conductor cross-section.

The present invention is characterized according to a preferred development in that the tool according to the invention comprises a hand lever pair, which is arranged to move the stamp element, relative to the mating bearing element, out of the application position to the clamping position and vice versa by means of manual operation on the stamp element and the mating bearing element, respectively, to form a tong-like linkage. In other words, the tool according to the invention is formed as tongs or clamping tongs. By means of the hand lever pair, one-handed operation of the tool according to the invention is possible. The linkage is advantageously designed as a parallel guide. In this way, the movement of the stamp element relative to the mating bearing element takes place purely translationally. The parallel orientation of the stamp element to the mating bearing element is always maintained in this case.

The insulation-displacement terminal according to the invention is adapted and designed to make clamping contact with an electrical conductor, which is sheathed by way of an insulation, by applying the above-described tool, and comprises at least two contact elements which each form a conductor clamping slot and are designed to make clamping contact with the electrical conductor, wherein at least one of the contact elements has a bearing face which faces away from the conductor clamping slot and is designed to come into contact with the mating bearing element of the tool. The bearing face designed to come into contact with the mating bearing element of the tool offers the advantage that clamping forces acting on the insulation-displacement terminal according to the invention during the clamping process are supported via the bearing face and the mating bearing element so that no outer forces are transferred to the terminal carrier, such as a terminal strip, circuit board, or the like, during the clamping process. The insulation-displacement terminal according to the invention is therefore, preferably, suitable for connecting electrical conductors of large cross-section.

An expedient development of the invention provides that at least one guide recess designed to engage in a form-fit manner in a respective guide element of the tool be arranged in a connecting region between two each of the contact elements. With the insulation-displacement terminal according to the invention, a guiding aid is thus provided, which allows accurate and precise alignment of the tool on the insulation-displacement terminal.

An advantageous development of the invention provides that at least two of the contact elements form lateral surfaces, designed to come into contact with the mating bearing element of the tool, of the insulation-displacement terminals. This offers the advantage that the aforementioned contact elements at the same time serve as a guiding aid to precisely align the tool so that the manufacturing effort for the insulation-displacement terminal according to the invention is as low as possible.

An advantageous development of the invention is characterized in that the contact elements have solder pins for mounting the conductor flaps of the insulation-displacement terminal. In particular, the contact elements and the solder pins are formed in one piece—for example, as a stamped part. In this way, the manufacturing effort is reduced to a minimum.

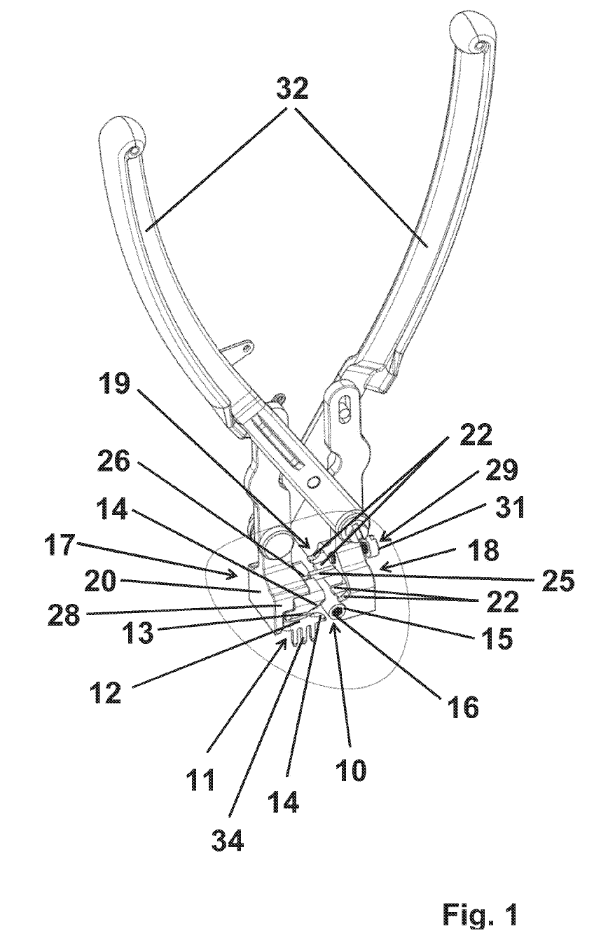

FIG. 1 shows a perspectival view of the tool according to the invention for connecting an electrical conductor 10, which is sheathed by way of an insulation, to an insulation-displacement terminal 11. FIG. 1 shows the tool according to the invention in an application position in which the tool is placed on the insulation-displacement terminal 11 in order to subsequently connect the electrical conductor 10, which is sheathed by way of an insulation 15, to the insulation-displacement terminal 11.

The insulation-displacement terminal 11 comprises at least two contact elements 12 which are designed to make clamping contact with the electrical conductor 10. For this purpose, the contact elements 12 each have a conductor clamping slot 13. The contact elements 12 preferably comprise cutting edges 14 by means of which the insulation 15 of the electrical conductor 10 is cut. The cutting edges 14 are, in particular, tapered in the direction of the conductor clamping slot 13 so that the core 16 of the electrical conductor 10 is mechanically held in the respective one of the conductor clamping slots 13 and at the same time electrically contacted.

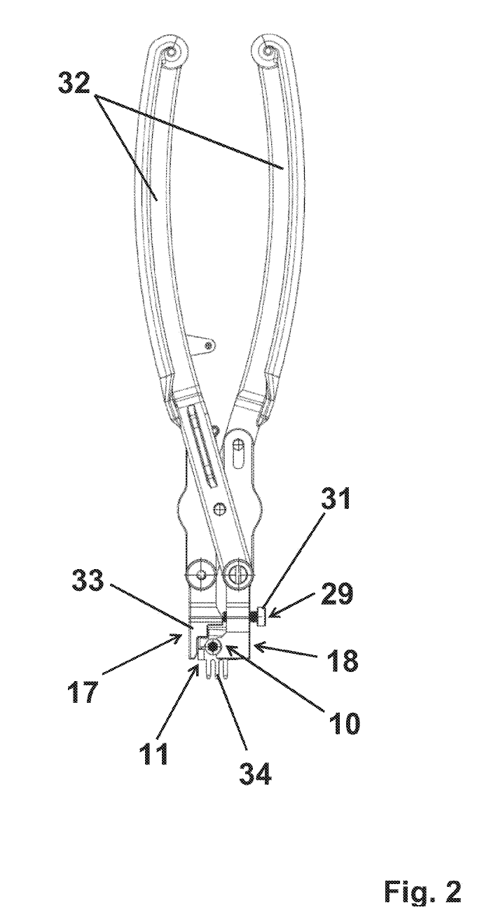

The tool according to the invention comprises a mating bearing element 17 designed to be placed against the contact elements 12. A stamp element 18 is arranged such that it can move, relative to the mating bearing element 17. The stamp element 18 and the mating bearing element 17 are designed so as to be movable relative to one another in such a way that they can be moved out of the application position shown in FIG. 1 to a clamping position shown in FIG. 2, and vice versa.

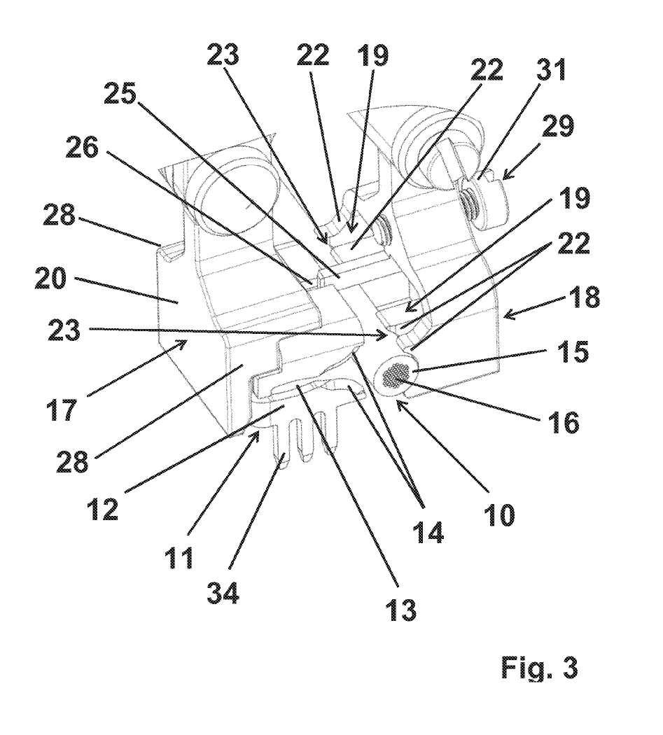

FIG. 3 shows the region outlined in FIG. 1 in an enlargement in detail. The stamp element 18 has a receiving element 19 for holding and guiding the electrical conductor 10. The receiving element 19 is formed and designed to insert the electrical conductor 10 into the conductor clamping slots 13 when the stamp element 18 moves, relative to the mating bearing element 17, out of the application position to the clamping position.

The mating bearing element 17 has at least one supporting region 20 designed to come into contact with at least one bearing face 21 of at least one of the contact elements 12. The bearing face 21 of the insulation-displacement terminal 11 is located on a side, which faces away from the respective conductor clamping slot 13, of the insulation-displacement terminal 11. In other words, the mating bearing element 17, with its supporting region 20, is designed to support the tool according to the invention on the rear side on the insulation-displacement terminal 11 so that the clamping forces of the stamp element 18 occurring when the electrical conductor 10 is inserted into the conductor clamping slots 13 of the insulation-displacement terminal 11 are completely absorbed by the tool according to the invention, and no outside forces act on the terminal carrier or on other components connected to the contact elements 12 during the clamping process.

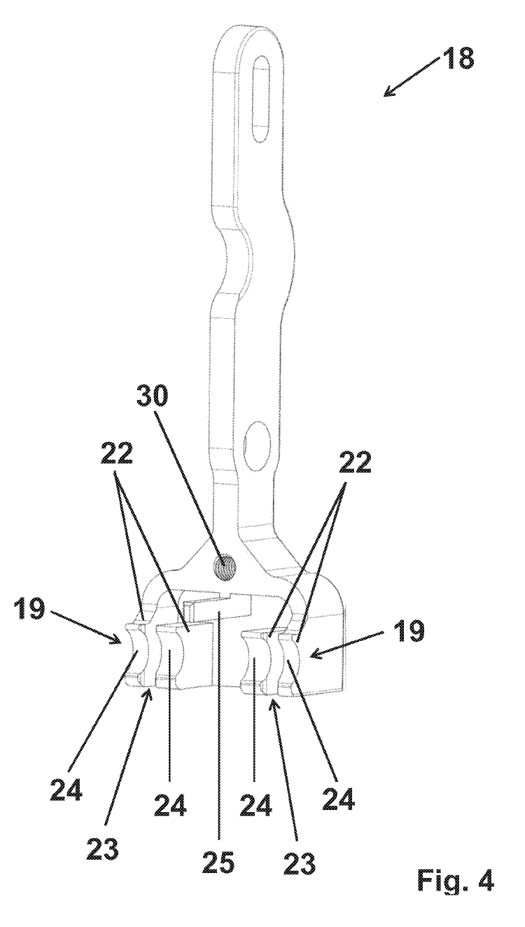

As can be gathered from the detailed illustration of the stamp element 18 in FIG. 4, the receiving element 19 preferably comprises a pair of pressing elements 22 assigned to each of the contact elements 12 of the insulation-displacement terminal 11. The pressing elements 22 are designed and formed to support the electrical conductor 10 during insertion into the respective one of the conductor clamping slots 13. Further preferred, the pressing elements 22 of a pair are arranged at a distance to one another to form a receiving gap 23. The receiving gap 23 is respectively designed to receive one of the contact elements 12. The distance between the pressing elements 22 of a pair is therefore preferably selected to be at least as large as the material thickness of the respective one of the contact elements 12.

Advantageously, the pressing elements 22 each have concave supporting surfaces 24. In particular, the concave supporting surfaces 24 are circular arc-shaped so that the electrical conductor 10 with insulation 15 comes into contact with the entirety of the supporting surfaces if possible.

The stamp element 18 preferably comprises at least one guide element 25. The guide element 25 is formed to engage in at least one guide recess 26. The at least one guide recess 26 is preferably arranged in a connecting region 27 between two each of the contact elements 12 of the insulation-displacement terminal 11. The guide element 25 engages in the guide recess 26 in a form-fit manner.

The mating bearing element 17 is preferably designed to laterally encompass the insulation-displacement terminal 11 and respectively comprises lateral guiding surfaces 28 for this purpose. The lateral guiding surfaces 28 are thus designed to center and align the mating bearing element 17 on the insulation-displacement terminal 11. The centering and alignment of the stamp element 18 is achieved by the interaction of the guide element 25 and the guide recess 26.

The lateral guiding surfaces 28 are, advantageously, formed in a staircase shape. The staircase shape of the lateral guiding surfaces 28 is respectively, in particular, designed such that the conductor clamping slots 13 are not covered when placing the mating bearing element 17 against the contact elements 12.

The stamp element 18 preferably comprises an adjustable limiting device 29. The limiting device 29 is configured to adjustably limit the minimum distance between the stamp element 18 and the mating bearing element 17. As shown in the drawing, the limiting device 29 is formed, for example, by a threaded bore 30 with an adjusting screw 31 arranged thereon. Alternatively, the limiting device 29 with the threaded bore 30 and the adjusting screw 31 is not arranged as shown in the drawing on the stamp element 18, but on the mating bearing element 17.

As FIGS. 1 and 2 show, the tool according to the invention further comprises a hand lever pair 32. The hand lever pair 32 is arranged on the stamp element 18 or the mating bearing element 17 to form a tong-like linkage. The tool according to the invention is consequently formed as a tongs tool. By manually operating the hand lever pair 32, the stamp element 18 can thus be moved, relative to the mating bearing element 17, out of the application position to the clamping position and vice versa. The aforementioned linkage is advantageously formed as a parallel guide so that the relative movement between the mating bearing element 17 and the stamp element 18 is purely translational. The mating bearing element 17 and the stamp element 18 are consequently designed to be moved towards or away from one another, while remaining parallel.

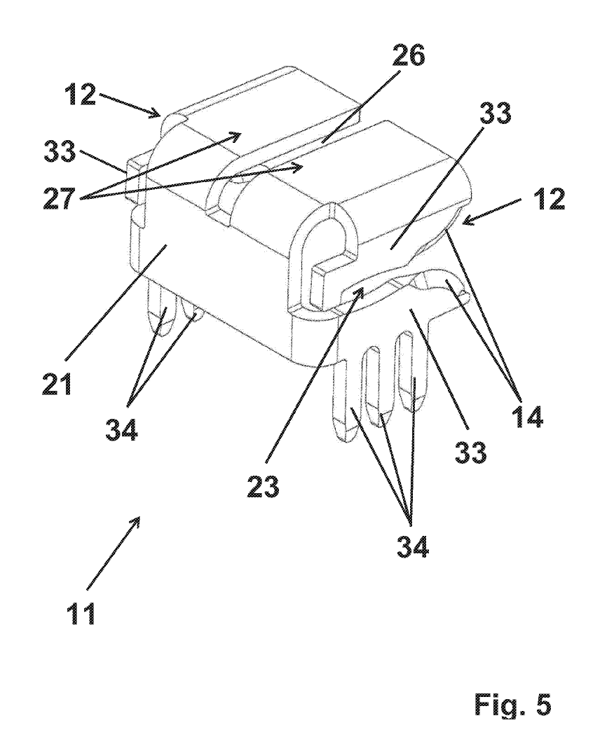

FIG. 5 shows a perspectival view of the insulation-displacement terminal 11 according to the invention. The insulation-displacement terminal 11 according to the invention is adapted and designed to make clamping contact with the electrical conductor 10, which is sheathed by way of an insulation 15, by applying the above-described tool according to the invention. The insulation-displacement terminal 11 comprises at least two of the contact elements 12 respectively forming the conductor clamping slot 13. At least one of the contact elements 12 comprises a bearing face 21 facing away from the conductor clamping slot 13 and designed to come into contact with the mating bearing element 17 of the tool according to the invention. As can be seen in FIG. 5, the bearing face 21 is preferably respectively arranged on both of the contact elements 12 and forms, with its position facing away from the conductor clamping slots 13, a rear wall element of the insulation-displacement terminal 11.

A guide recess 26 is preferably arranged in the connecting region 27 between two each of the contact elements 12. The guide recess 26 is formed, and designed to engage in a form-fit manner, in a respective guide element 25 of the tool according to the invention. Advantageously, one of the guide recesses 26 is respectively arranged between two of the contact elements 12.

In particular, at least two of the contact elements 12 form the lateral surfaces 33 of the insulation-displacement terminal 11 according to the invention. The lateral surfaces 33 are thus formed and designed to come into contact with the mating bearing element 17.

Further preferred, the contact elements 12 respectively comprise solder pins 34 for mounting the conductor flaps of the insulation-displacement terminal 11 according to the invention.

The insulation-displacement terminal 11 according to the invention is preferably integrally-formed—for example, as a stamped part. The insulation-displacement terminal 11 according to the invention is not limited to the embodiment shown in the drawing as a clamp for mounting the conductor flaps. Instead of the solder pins 34, it is, rather, possible to connect the contact elements 12 to other terminal carriers, e.g., via a current bar, with further electrical assemblies.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMBERS

10 Electrical conductor
11 Insulation-displacement terminal
12 Contact elements
13 Conductor clamping slot
14 Cutting edges
15 Insulation
16 Core
17 Mating bearing element
18 Stamp element
19 Receiving element
20 Supporting region
21 Bearing face
22 Pressing elements
23 Receiving gap
24 Concave supporting surfaces
25 Guide element
26 Guide recess
27 Connecting region
28 Lateral guiding surfaces
29 Limiting device
30 Threaded bore
31 Adjusting screw
32 Hand lever pair
33 Lateral surfaces
34 Solder pins

1. A tool for connecting an electrical conductor, which is sheathed by an insulation, to an insulation-displacement terminal which has at least two contact elements which each form a conductor clamping slot and are configured to make clamping contact with the electrical conductor, the tool comprising:
a mating bearing element, which is configured to be placed against the contact elements; and
a stamp element, which is arranged so as to be movable, relative to the mating bearing element, the stamp element having a receiving element configured to hold and guide the electrical conductor, which receiving element is formed and configured to insert the electrical conductor into the conductor clamping slots when the stamp element moves, relative to the mating bearing element, out of an application position to a clamping position,
wherein the mating bearing element has at least one supporting region which is configured to come into contact with at least one bearing face, which is averted from the conductor clamping slot, of at least one of the contact elements in the application position.

2. The tool according to claim 1, wherein the receiving element comprises a pair of pressing elements assigned to each of the contact elements of the insulation-displacement terminal, which pressing elements are configured to support the electrical conductor during insertion into the respective conductor clamping slot.

3. The tool according to claim 2, wherein each of the pairs of pressing elements comprises two pressing elements which are spaced apart from one another to form a receiving gap configured to receive the contact elements.

4. The tool according to claim 2, wherein the pressing elements each have concave supporting surfaces.

5. The tool according to claim 1, wherein the stamp element comprises at least one guide element which is configured and formed to engage in a form-fit manner in at least one guide recess of the insulation-displacement terminal, and
wherein the at least one guide recess is arranged in a connecting region between two each of the contact elements of the insulation-displacement terminal.

6. The tool according to claim 1, wherein the mating bearing element respectively has lateral guiding surfaces configured to laterally encompass the insulation-displacement terminal.

7. The tool according to claim 6, wherein the lateral guiding surfaces are configured in a staircase shape so that, when placing them against the contact elements, the conductor clamping slots are not covered.

8. The tool according to claim 1, wherein the stamp element and/or the mating bearing element has an adjustable limiting device configured to limit a minimum distance between the stamp element and the mating bearing element.

9. The tool according to claim 1, further comprising a hand lever pair which, in order to move the stamp element, relative to the mating bearing element, out of the application position to the clamping position and vice versa by manual operation, is arranged on the stamp element and the mating bearing element, respectively, to form a tong-like linkage.

10. The tool according to claim 9, wherein the linkage comprises a parallel guide.

11. An insulation-displacement terminal configured to make clamping contact with an electrical conductor, which is sheathed by way of an insulation, by applying a tool according to claim 1, the insulation-displacement terminal comprising:
at least two contact elements which each form a conductor clamping slot and are configured to make clamping contact with the electrical conductor,
wherein at least one of the contact elements comprises a bearing face facing away from the conductor clamping slot and is configured to come into contact with the mating bearing element of the tool.

12. The insulation-displacement terminal according to claim 11, wherein at least one guide recess configured to engage in a form-fit manner in a respective guide element of the tool is arranged in a connecting region between two each of the contact elements.

13. The insulation-displacement terminal according to claim 11, wherein at least two of the contact elements form lateral surfaces, configured to come into contact with the mating bearing element of the tool, of the insulation-displacement terminal.

14. The insulation-displacement terminal according to claim 11, wherein the contact elements have solder pins configured for circuit board mounting of the insulation-displacement terminal.
